(19) United States
(12) Patent Application Publication
(10) Pub. No.: US 2012/0163278 A1
(43) Pub. Date: Jun. 28, 2012

(54) METHOD FOR PERFORMING DIRECT COMMUNICATION BETWEEN TERMINALS

(75) Inventors: Sung Cheol CHANG, Daejeon (KR); Eunkyung Kim, Daejeon (KR); Sung Kyung Kim, Daejeon (KR); Hyun Lee, Daejeon (KR); Chul Sik Yoon, Seoul (KR)

(73) Assignee: ELECTRONICS AND TELECOMMUNICATIONS RESEARCH INSTITUTE, Daejeon (KR)

(21) Appl. No.: 13/336,897

(22) Filed: Dec. 23, 2011

(30) Foreign Application Priority Data
Dec. 24, 2010 (KR) 10-2010-0134911
Dec. 24, 2010 (KR) 10-2010-0134913
Dec. 23, 2011 (KR) 10-2011-0141643
Dec. 23, 2011 (KR) 10-2011-0141645

(51) Int. Cl. H04W 72/04; H04W 4/06

(52) U.S. Cl. 370/312

(57) ABSTRACT

A method for performing direct communication, by a first terminal, between terminals, includes transmitting a control message for a direct communication resource allocation to at least one second terminal through a first region included in a direct communication resource, transmitting synchronization information to at least one second terminal through a second region included in the direct communication resource, and transmitting a data packet to at least one second terminal through a third region included in the direct communication resource.

### CROSS-REFERENCE TO RELATED APPLICATION

This application claims priority to and the benefit of Korean Patent Application Nos. 10-2010-0134913, 10-2010-0134911, 10-2011-0141643, and 10-2011-0141645 filed in the Korean Intellectual Property Office on Dec. 24, 2010, Dec. 24, 2010, Dec. 23, 2011, and Dec. 23, 2011, the entire contents of which are incorporated herein by reference.

### BACKGROUND OF THE INVENTION

(a) Field of the Invention

The present invention relates to direct communication. More particularly, the present invention relates to a method for performing direct communication between terminals.

(b) Description of the Related Art

Direct communication refers to signal transmission and reception between terminals without a base station's mediation or control therebetween. To date, direct communication has been implemented based on TETRA technology, but broadband is required to be used for a high speed transmission. However, narrowband is still required to be used to enlarge a communication distance and transmit voice traffic. Namely, a system for simultaneously using broadband and narrowband is required.

Also, demand for simultaneous communication between or among multiple users is on the rise.

Further, for a continuous direct communication operation of a mobile terminal, the mobile terminal is required to be operated in an infrastructure mode and in a green field mode.

In addition, a means (or a method) for changing allocated resource when interference is recognized is required.

### SUMMARY OF THE INVENTION

The present invention has been made in an effort to provide a method for performing direct communication between terminals.

An exemplary embodiment of the present invention provides a method for performing direct communication, by a first terminal, between terminals, including: multicasting a control message including resource allocation information and a group ID to a plurality of second terminals through a first region included in a direct communication resource; and multicasting a data packet to a plurality of second terminals corresponding to the group ID through a second region included in the direct communication resource allocated by the control message.

Another embodiment of the present invention provides a method for performing direct communication, by a first terminal, between terminals, including: receiving a signal from a second terminal; transmitting a control message including resource allocation information to at least one third terminal through the first region included in the direct communication resource; and transmitting the signal received from the second terminal to the at least one third terminal through the second region included in the direct communication resource allocated by the control message.

Yet another embodiment of the present invention provides a method for performing direct communication, by a first terminal, between terminals, including: transmitting a control message for direct communication resource allocation to at least one second terminal through a first region included in a direct communication resource; and transmitting a data packet to at least one second terminal through a second region included in the direct communication resource.

### BRIEF DESCRIPTION OF THE DRAWINGS

FIG. 1 is a view showing a frame structure representing resource for direct communication according to an embodiment of the present invention.

FIG. 2 is a view showing a resource allocation structure based on an FDM scheme according to an embodiment of the present invention.

FIG. 3 is a view showing a resource allocation structure based on a TDM scheme according to an embodiment of the present invention.

FIG. 4 is a view showing a direct communication resource according to an embodiment of the present invention.

FIG. 5 is a view showing a structure of a direct communication resource according to an embodiment of the present invention.

FIG. 6 is a view showing a one-to-many direct communication procedure according to an embodiment of the present invention.

FIG. 7 is a view showing a multicast resource allocation procedure according to an embodiment of the present invention.

FIG. 8 is a view showing a direct communication relay procedure according to an embodiment of the present invention.

FIG. 9 is a view showing a unicast transmission procedure based on a half-duplex scheme according to an embodiment of the present invention.

FIG. 10 is a view showing a unicast transmission procedure based on a full-duplex scheme according to an embodiment of the present invention.

FIG. 11 is a view showing a synchronization procedure according to an embodiment of the present invention.

FIG. 12 is a view showing a synchronization procedure according to another embodiment of the present invention.

FIG. 13 is a view showing a resource management method for direct communication according to an embodiment of the present invention.

FIG. 14 is a view showing a resource management method for direct communication according to another embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Throughout the specification, a mobile station (MS) may refer to a terminal, a mobile terminal (MT), a subscriber station (SS), a portable subscriber station (PSS), an access terminal (AT), user equipment (UE), or the like, and may include an entirety or a portion of functions of a terminal, an MT, an SS, a PSS, an AT, a UE, and the like.

Also, a base station (BS) may refer to a node B, an evolved node B (eNodeB), an access point (AP), a radio access station (RAS), a base transceiver station (BTS), a mobile multihop relay (MMR)-BS, and the like, and may include an entirety or a portion of functions of a node B, an eNodeB, an AP, a RAS, a BTS, an MMR-BS, and the like.

Hereinafter, a method for managing resource for direct communication between terminals according to an embodiment of the present invention will be described with reference to the accompanying drawings.

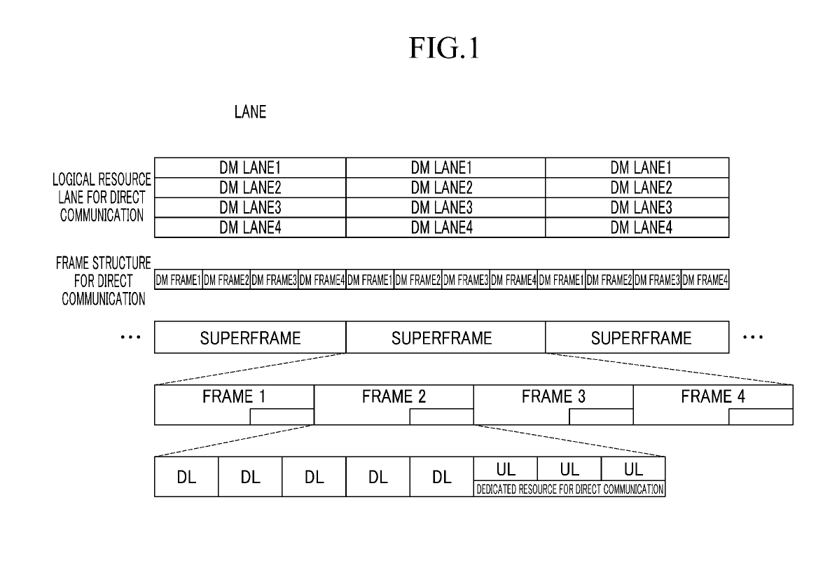

FIG. 1 is a view showing a frame structure representing resource for direct communication according to an embodiment of the present invention.

With reference to FIG. 1, a superframe includes a plurality of frames, and each of the frames includes a plurality of subframes. Some of the subframes in each frame may be allocated to an uplink (UL) resource region and the remaining subframes may be allocated to a downlink (DL) resource region.

In the present disclosure, a portion of the uplink resource region is illustrated as a radio resource for direct communication, but the present invention is not limited thereto. An infrastructure communication between a base station and a terminal may not use a radio resource for direct communication. Terminals participating in direct communication may perform direct communication by using a direct communication protocol and procedure through a dedicated resource for direct communication. Hereinafter, a dedicated resource for direct communication may be used together with a direct mode zone or direct communication resource.

A direct communication resource allocated to some of the plurality of frames included in each of the superframes and a direct communication resource allocated to the remaining frames may be discriminated. For example, a direct communication resource included in a first frame of each of the superframes forms a direct mode lane corresponding to a direct mode lane No. 1, a direct communication resource included in a second frame of each of the superframes forms a direct mode lane corresponding to a direct mode lane No. 2, a direct communication resource included in a third frame of each of the superframes forms a direct mode lane corresponding to a direct mode lane No. 3, and a direct communication resource included in a fourth frame of each of the superframes forms a direct mode lane corresponding to a direct mode lane No. 4. With respect to a single terminal, a single direct mode lane may be dedicatedly used for reception or transmission. For example, when a mobile terminal uses the direct mode lane corresponding to the direct mode lane No. 1 for reception, it cannot use the same lane for transmission.

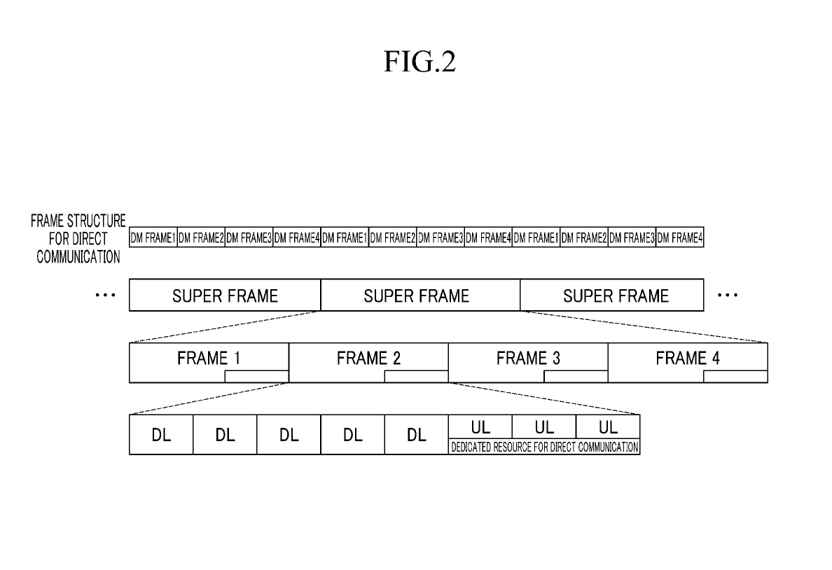

FIG. 2 is a view showing a resource allocation structure based on an FDM scheme according to an embodiment of the present invention.

With reference to FIG. 2, a direct communication resource may be allocated in an FDM manner. Namely, a partial frequency section of an uplink resource may be allocated for direct communication. In this case, high power per resource can be allocated with particular timing, advantageously lengthening a transmission distance. Meanwhile, a direct communication resource and an uplink resource used for infrastructure communication are dependent. Thus, there is a problem in which it is not possible to receive a signal from a counterpart terminal that performs direct communication by using the direct communication resource and simultaneously transmitting an uplink signal to a base station through infrastructure communication.

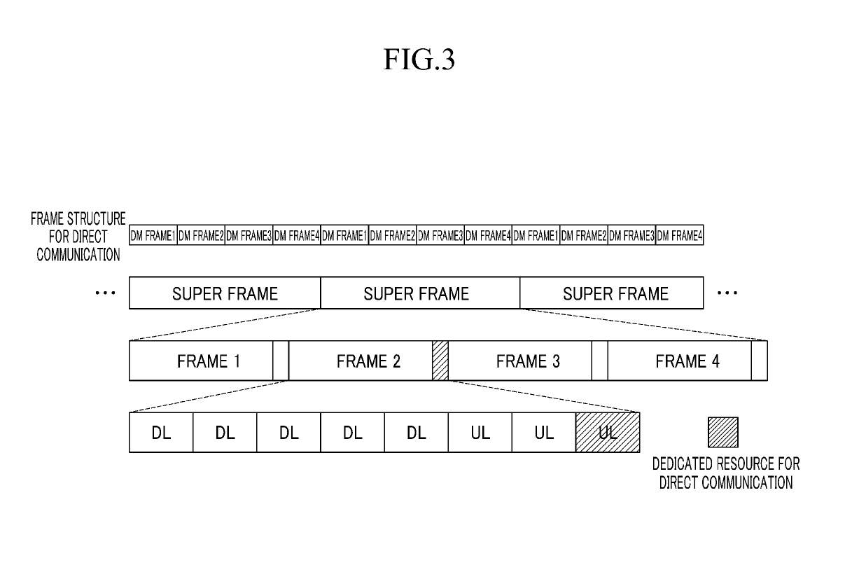

FIG. 3 is a view showing a resource allocation structure based on a TDM scheme according to an embodiment of the present invention.

With reference to FIG. 3, the direct communication resource may be allocated in a TDM manner. Namely, some uplink subframes may be allocated for direct communication. As illustrated in FIG. 3, the direct communication resource and the uplink resource in an infrastructure mode are independent. Thus, transmission and reception of the direct communication resource and transmission of the infrastructure mode uplink resource are advantageously unrelated. Meanwhile, relatively lower power per resource is allocated with particular timing, so a transmission distance can be shortened.

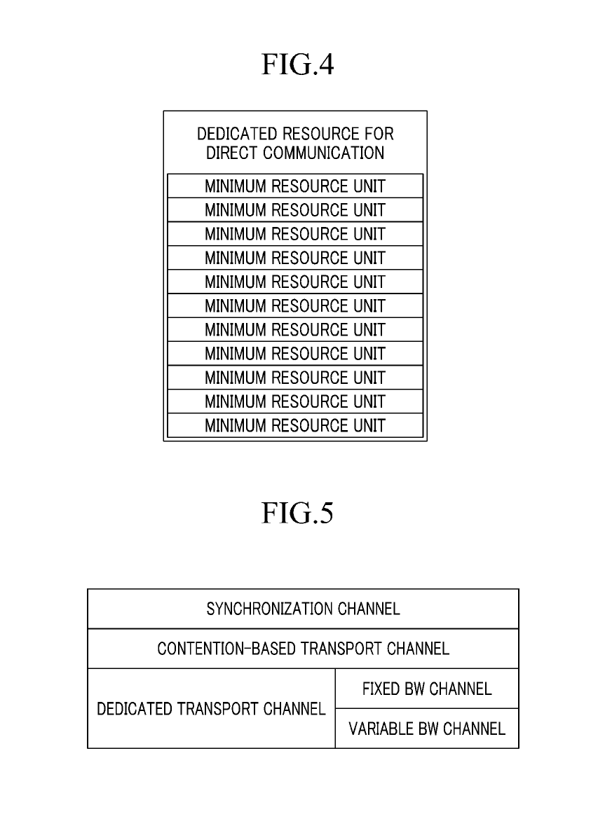

FIG. 4 is a view showing the direct communication resource according to an embodiment of the present invention.

With reference to FIG. 4, the dedicated resource for direct communication may include a plurality of minimum resource units. Each minimum resource unit, which is an allocation unit of a minimum resource for direct communication, may have a different structure from that of the existing PRU. Currently, a minimum resource unit is an FFS which is a conceptual unit.

FIG. 5 is a view showing a structure of the direct communication resource according to an embodiment of the present invention.

With reference to FIG. 5, direct communication uses a synchronization channel, a contention-based transport channel, and a dedicated transport channel. The dedicated transport channel includes a fixed dedicated BW channel and a variable dedicated BW channel.

The synchronization channel may be disposed at a fixed position of the direct communication resource. A terminal may transmit a beacon of the 802.11 standard through a synchronization channel in a contending manner,

The synchronization channel may transmit synchronization information.

A contention-based transport channel may be disposed at a fixed position of the direct communication resource. The contention-based transport channel may transmit a control message for direct communication resource allocation. Namely, a terminal may allocate resource of the fixed dedicated channel by using the contention-based transport channel. The contention-based transport channel may be used together with a contending channel.

The fixed dedicated channel is a channel that is continuously occupied in a single direct communication resource, and may be released by an inband signal.

The variable dedicated channel is a channel that is allocated and released by an inband signal of the fixed dedicated channel. The dedicated transport channel including the fixed dedicated channel and the variable dedicated channel may be used together with a dedicated channel.

Hereinafter, one-to-many (1:N) direct communication in which a single transmission terminal performs direct communication with a plurality of reception terminals will be described.

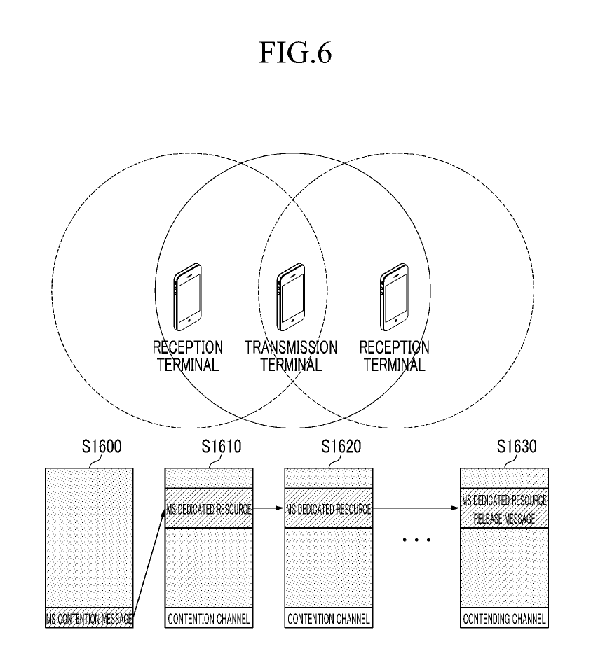

FIG. 6 is a view showing a one-to-many direct communication procedure according to an embodiment of the present invention.

With reference to FIG. 6, the transmission terminal may perform direct communication with a plurality of reception terminals by using a direct communication resource including a contending channel and a dedicated channel. To this end, the transmission terminal transmits a contending message including resource allocation information and a multicast group ID through a contending channel (S1600). Thus, the transmission terminal obtains a dedicated resource to be used for multicasting including one or more minimum resource units in a dedicated channel (S1610). In order to resolve collision in a contending channel, the terminal may use a binary exponential backoff algorithm. Further, an additional collision detection scheme and collision resolution scheme may be considered. Also, an additional scheme for detecting collision of an allocated resource and an additional scheme for resolving collision may be considered. Further, a scheme for obtaining reliability of additional allocation information and a synchronization error scheme may also be considered.

Thereafter, the transmission terminal multicasts or broadcasts data such as user traffic and control information to a terminal group corresponding to a multicast group ID through the obtained dedicated resource (S1620).

When the terminal determines that the obtained dedicated resource is no longer necessary, the terminal transmits a dedicated resource release message to release the dedicated resource (S1630).

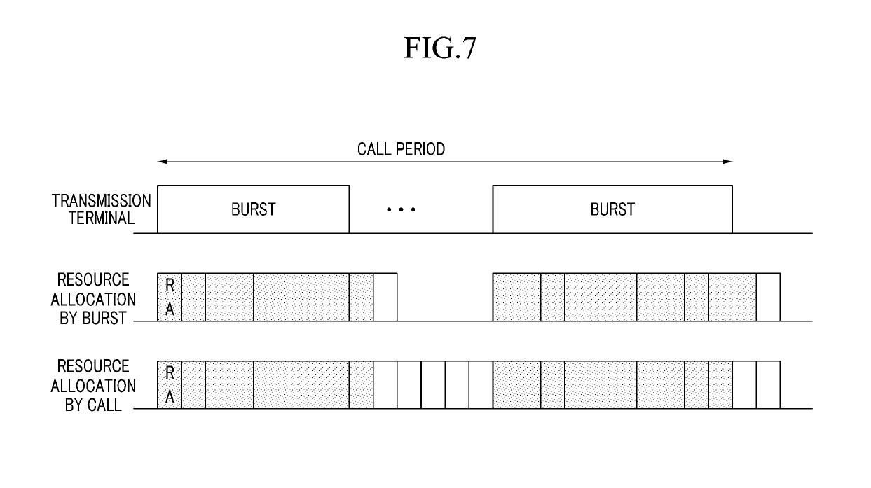

FIG. 7 is a view showing a multicast resource allocation procedure according to an embodiment of the present invention.

With reference to FIG. 7, a multicast resource may be allocated in units of burst (or by burst) or by call. In the case of resource allocation by burst, the terminal transmits a contending message by burst to obtain (or secure) the dedicated resource, and transmits a message through the obtained dedicated resource. In the case of resource allocation by call, the terminal transmits a contending message when a call is set up to obtain the dedicated resource, and maintains the dedicated resource even when there is no burst transmission. When the call is terminated, the terminal releases the dedicated resource through a release message.

Hereinafter, content of relaying direct communication by a relay terminal will be described.

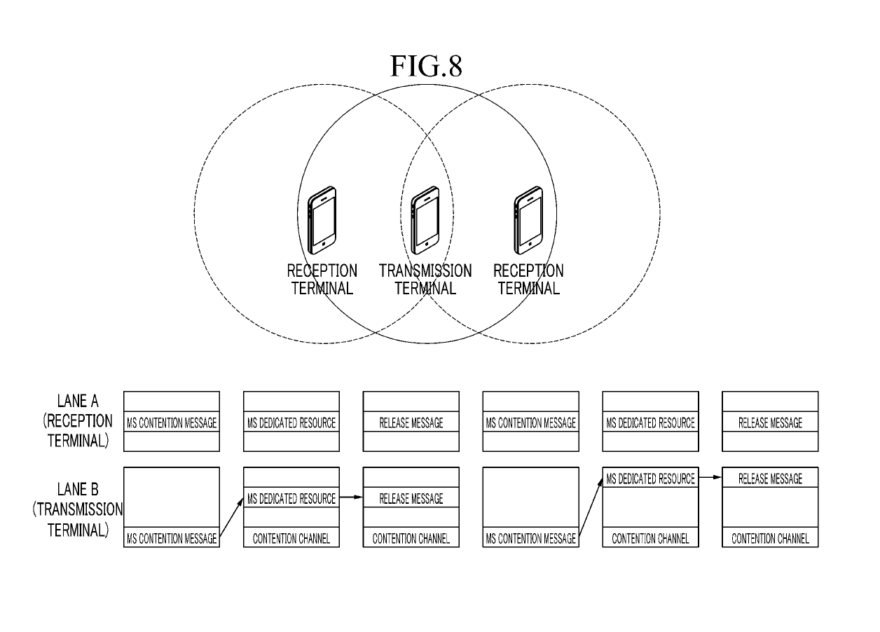

FIG. 8 is a view showing a direct communication relay procedure according to an embodiment of the present invention.

With reference to FIG. 8, communication areas of a transmission terminal, a relay terminal, and a reception terminal are different.

In particular, when the relay terminal is a supervisor, a signal arrival area of the relay terminal may be a multicast communication area. Thus, a signal transmitted by the relay terminal may be received by every terminal within the signal arrival area, but a signal transmitted by the transmission terminal may not be received by the reception terminal. Thus, the relay terminal may serve as a repeater (or relay) relaying a signal transmitted from a neighboring terminal.

In detail, when the relay terminal receives a signal transmitted from a neighboring terminal, it can broadcast the corresponding signal through the obtained dedicated resource. Also, the relay terminal may obtain an additional dedicated resource from a different lane from a lane to which dedicated resource obtained through a contending message belongs, to broadcast the corresponding signal.

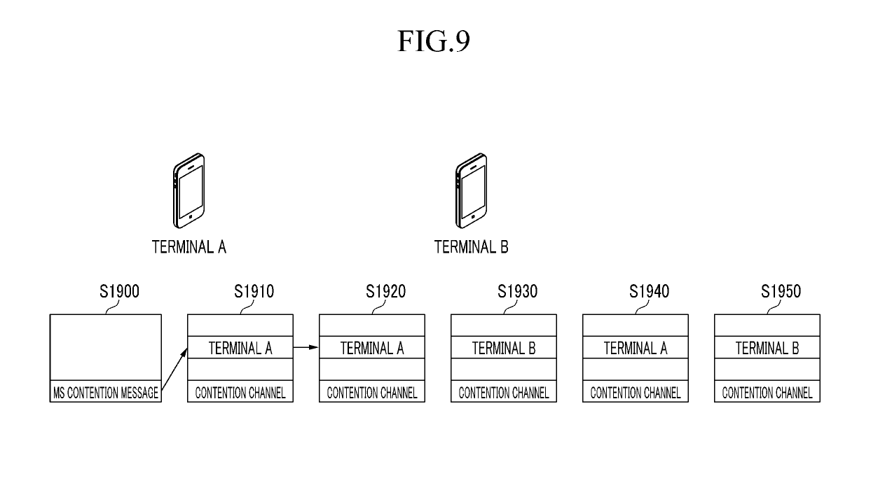

FIG. 9 is a view showing a unicast transmission procedure based on a half-duplex scheme according to an embodiment of the present invention.

With reference to FIG. 9, the transmission terminal secures (or obtains) a dedicated resource from one of a plurality of lanes through a contending message (S1900). Thereafter, the transmission terminal transmits traffic or a control signal to the reception terminal through the obtained dedicated resource (S1910). When the transmission terminal has no data to be transmitted, the transmission terminal transmits an authority transfer message to the reception terminal through the dedicated resource (S1920). When the reception terminal receives the authority transfer message (S1930), the reception terminal checks whether or not it has data to be transmitted to the transmission terminal (S1940). When the reception terminal has data to be transmitted, the reception terminal transmits the data through obtained dedicated resource (S1950). Meanwhile, when the reception terminal does not have data to be transmitted, the reception terminal transmits the authority transfer message to the transmission terminal through the obtained dedicated resource.

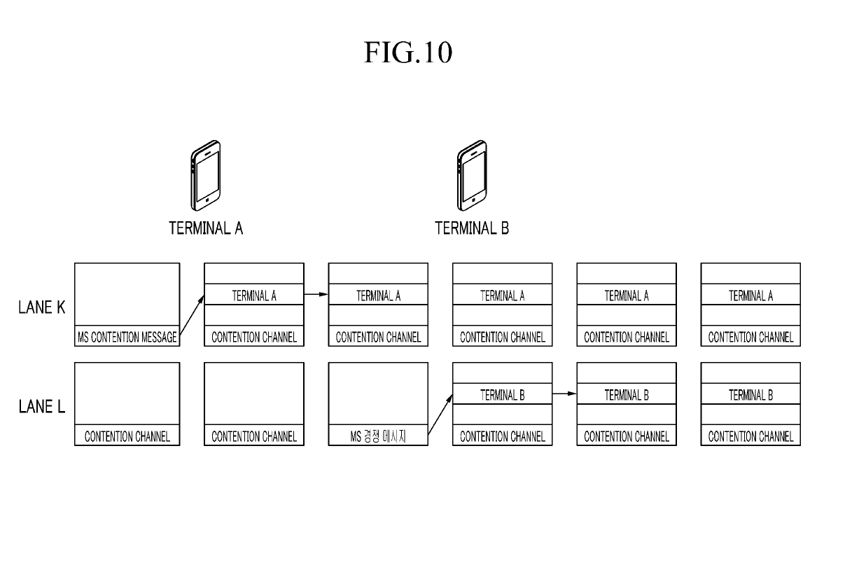

FIG. 10 is a view showing a unicast transmission procedure based on a full-duplex scheme according to an embodiment of the present invention.

With reference to FIG. 10, when the transmission terminal and the reception terminal have data to be transmitted to each other, they obtain a dedicated resource through contending messages from different lanes, and transmit data to each other through the obtained dedicated resources.

In detail, the transmission terminal obtains a dedicated resource from one of the plurality of lanes through a contending message. Thereafter, the transmission terminal transmits traffic or a control signal to the reception terminal through the obtained dedicated resource.

Meanwhile, when the reception terminal has data to be transmitted to the transmission terminal, the reception terminal obtains a dedicated resource through a contending message from a lane (lane L) other than the lane from which the transmission terminal has obtained a resource. Further, the reception terminal transmits traffic or a control signal to the transmission terminal through the obtained dedicated resource.

Hereinafter, a synchronization procedure for synchronizing terminals in direct communication will be described.

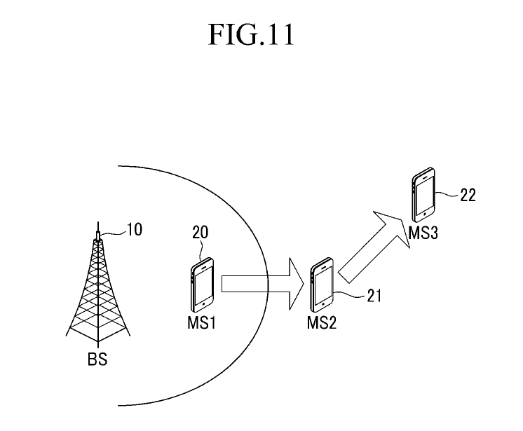

FIG. 11 is a view showing a synchronization procedure according to an embodiment of the present invention.

With reference to FIG. 11, for direct communication, terminals 21 and 22 outside an infrastructure communication area, as well as a terminal 20 within the infrastructure communication area, should obtain synchronization. The terminal 20 located within a cell of a base station 10 may receive a signal from the base station 10. Accordingly, the terminal 20 can obtain synchronization information of the infrastructure. However, the terminals 21 and 22 located outside the cell of the base station 10 cannot receive a signal from the base station 10. Thus, the terminals 21 and 22 cannot directly obtain synchronization information of the infrastructure.

Thus, the terminal 20 located in the cell propagates (or transmits) the synchronization information of the infrastructure (in particular, uplink subframe configuration information) obtained under particular conditions to the neighboring terminal 21. In particular, the terminal 20 may propagate the synchronization information of the infrastructure by using a synchronization channel at a fixed position as described above.

The terminal 21, which has obtained the synchronization information of the infrastructure from the terminal located in the cell, also propagates the synchronization information to allow the terminal 22 located at a long distance from the cell to obtain the synchronization information of the infrastructure.

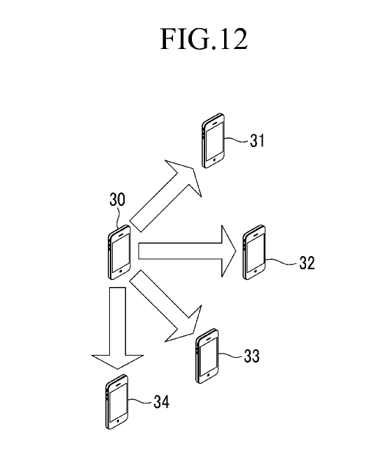

FIG. 12 is a view showing a synchronization procedure according to another embodiment of the present invention.

With reference to FIG. 12, the terminal 30 may provide synchronization information of the infrastructure to a plurality of neighboring terminals 31, 32, 33, and 34.

Meanwhile, standby sections for the terminal within the base station area and the terminal outside the base station area to transmit synchronization information may be discriminated, so that the terminal within the base station area and the terminal outside the base station area may propagate the synchronization information through the discriminated standby sections, respectively.

Hereinafter, a resource management method for direct communication will be described.

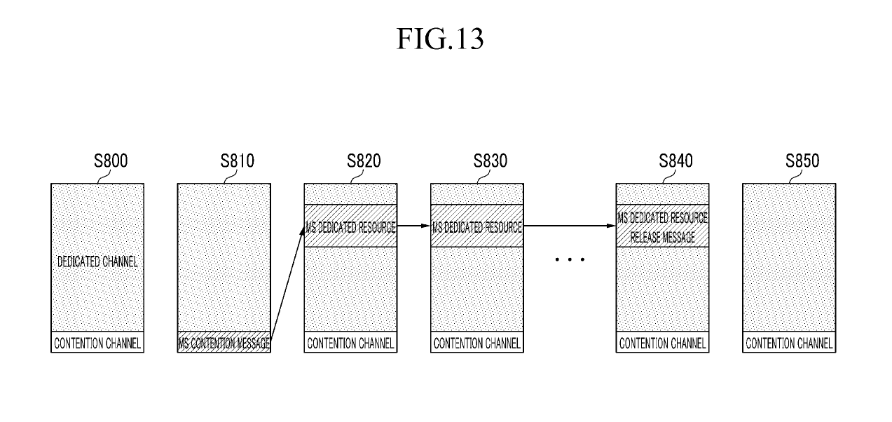

FIG. 13 is a view showing a resource management method for direct communication according to an embodiment of the present invention.

With reference to FIG. 13, a terminal may perform direct communication with at least one terminal by using a direct communication resource including a contending channel and a dedicated channel (S800). To this end, the terminal transmits a contending message including resource allocation information through a contending channel (S810). Accordingly, the terminal can obtain a portion of a dedicated channel as a dedicated resource (S820). The dedicated resource may include at least one minimum resource unit. In order to resolve collision in the contending channel, the terminal may use a binary exponential backoff algorithm. Besides, an additional collision detection scheme and collision resolution scheme may be considered. Also, an additional scheme for detecting collision of the allocated resource and an additional scheme for resolving collision may be considered. Further, a scheme for obtaining reliability of additional allocation information and a synchronization error scheme may also be considered.

Thereafter, the terminal transmits a data packet such as user traffic or control information to a different terminal or a terminal group through the obtained dedicated resource (S830).

When the terminal determines that the obtained dedicated resource is no longer necessary, the terminal may transmit a dedicated resource release message through the dedicated resource (S840). Accordingly, the dedicated resource for direct communication of the terminal is released (S850).

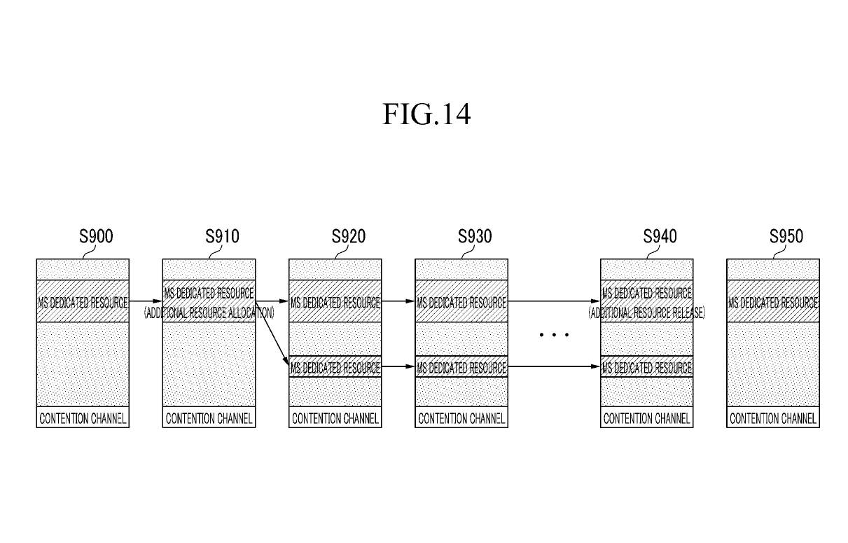

FIG. 14 is a view showing a resource management method for direct communication according to another embodiment of the present invention.

With reference to FIG. 14, while performing direct communication by using the dedicated resource for direct communication, the terminal may require an additional resource (S900). In this case, if the terminal transmits data through the dedicated resource, the terminal may not be able to monitor an available resource region in the direct communication resource to which the dedicated resource belongs. This is because, with respect to a single terminal, a single direct communication resource (lane) can be selected only for exclusive use of transmission or exclusive use of reception. Thus, the terminal may receive information regarding the available resource region from a counterpart terminal from a lane other than a lane to which the dedicated resource belongs, and transmit a resource allocation message including resource allocation information regarding a portion of the available resource region through the dedicated resource to an obtain additional dedicated resource (S910). Thereafter, the terminal transmits traffic and a control signal by using the dedicated resource and the additional dedicated resource (S920, S930). When the additional dedicated resource is no longer necessary, the terminal may transmit an additional dedicated resource release message through the dedicated resource (S940). Accordingly, the additional dedicated resource may be released (S950).

Meanwhile, the terminal can obtain an additional dedicated resource from a different lane from the lane to which the dedicated resource belongs. In this case, as described above with reference to FIG. 13, the terminal obtains the additional dedicated resource by transmitting an additional dedicated resource allocation message through a contending channel of a different lane.

According to the characteristics of the present invention, both broadband and narrowband can be used together, multiple users can perform communication simultaneously, an infrastructure mode and a green field mode can be operated, and a resource can be changed over interference.

Also, the embodiments of the present invention may not necessarily be implemented only through the foregoing devices and methods, but may also be implemented through a program for realizing functions corresponding to the configurations of the embodiments of the present invention, a recording medium including the program, or the like.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for performing direct communication, by a first terminal, between terminals, the method comprising:
multicasting a control message including resource allocation information and a group ID to a plurality of second terminals through a first region included in a direct communication resource; and
multicasting a data packet to a plurality of second terminals corresponding to the group ID through a second region included in the direct communication resource allocated by the control message.

2. The method of claim 1, wherein the second region is sustained until a call is terminated.

3. A method for performing direct communication, by a first terminal, between terminals, the method comprising:
receiving a signal from a second terminal;
transmitting a control message including resource allocation information to at least one third terminal through the first region included in the direct communication resource; and
transmitting the signal received from the second terminal to the at least one third terminal through the second region included in the direct communication resource allocated by the control message.

4. The method of claim 3, wherein when a plurality of third terminals exist, the control message further comprises a group ID identifying direct communication between the first terminal and the plurality of third terminals.

5. The method of claim 3, wherein the direct communication resource is included in a resource region including a plurality of superframes, each of the superframe comprises a plurality of frames, each of the plurality of frames comprises a plurality of subframes, some of the plurality of subframes are allocated to an uplink resource region and the remaining subframes are allocated to a downlink resource region, and the direct communication resource is allocated to a portion of the uplink resource region.

6. The method of claim 5, wherein the direct communication resource comprises a first direct communication resource allocated to some of the plurality of frames included in each of the superframes and a second direct communication resource allocated to the other remaining frames.

7. The method of claim 6, wherein the first terminal transmits data to the second terminal through the first direct communication resource, and the second terminal transmits data to the first terminal through the second direct communication resource.

8. A method for performing direct communication, by a first terminal, between terminals, the method comprising:
transmitting a control message for direct communication resource allocation to at least one second terminal through a first region included in a direct communication resource; and
transmitting a data packet to at least one second terminal through a second region included in the direct communication resource.

9. The method of claim 8, wherein the direct communication resource is included in a resource region including a plurality of superframes, each of the superframe comprises a plurality of frames, each of the plurality of frames comprises a plurality of subframes, some of the plurality of subframes are allocated to an uplink resource region and the remaining subframes are allocated to a downlink resource region, and the direct communication resource is allocated to a portion of the uplink resource region.

10. The method of claim 9, wherein the direct communication resource is allocated in a frequency division multiplex (FDM) or a time division multiplex (TDM).

11. The method of claim 9, wherein the direct communication resource comprises a first direct communication resource allocated to some of the plurality of frames included in each of the superframes and a second direct communication resource allocated to the remaining frames.

12. The method of claim 11, wherein available resource allocation information of the second direct communication resource is transmitted through the first direct communication resource.

13. The method of claim 8, wherein the direct communication resource comprises a plurality of minimum resource units.

14. A method for performing direct communication, by a first terminal, between terminals, the method comprising:
transmitting a control message for direct communication resource allocation to at least one second terminal through a first region included in a direct communication resource;
transmitting synchronization information to at least one second terminal through a second region included in the direct communication resource; and
transmitting a data packet to at least one second terminal through a third region included in the direct communication resource.

15. The method of claim 14, wherein the synchronization information is synchronization information of an infrastructure.
